(19) United States
(12) Patent Application Publication
(10) Pub. No.: US 2002/0148383 A1
(43) Pub. Date: Oct. 17, 2002

(54) Glazing compound

(76) Inventor: Matthew R. Harding, Jacksonville, FL (US)

Correspondence Address: Thomas C. Saitta, Rogers Tower Bailey Jones & Gay, P.A., 1301 Riverplace Blvd., Suite 1500, Jacksonville, FL, 32207, US

(21) Appl. No.: 09/834,467

(22) Filed: Apr. 13, 2001

(51) Int. Cl. C09D 5/14; C09D 5/16; C09D 5/18

(52) U.S. Cl. 106/15.05; 106/18.32

(57) ABSTRACT

A glazing compound additive comprising fine calcium carbonate and a mildicide in a weight ratio of approximately 8:3, where approximately 8 ounces of fine calcium carbonate and approximately 3 ounces of mildicide are added per gallon glazing compound.

### BACKGROUND OF THE INVENTION

This invention relates generally to the field of glazing compounds or glazing putty used to seal or reseal glass window panes in a window frame, and more particularly to glazing compounds which are mildew-resistant.

Glazing compound or putty is a composition which is somewhat elastic or plastic in nature such that the material is suitably pliable for easy handling and application, yet has enough consistency to remain in place to form a suitable flexible seal between the glass pane and the frame of the window, where the seal does not harden to the extent that cracking develops. Glazing compounds vary in composition and typically contain a binder or filler for body, often called a pigment, and an oil for plasticity. The amount, type and particle size of pigment present relative to the amount and type of oil present determines the physical properties of the glazing compound. A preferred composition for general use comprises a mixture of calcium carbonate, vegetable oil, marine or fish oil, and talc, as this produces a glazing compound with good shelf life, stability, oil retention, handling and knifing characteristics.

A major problem with the known glazing compounds, especially in the southern United States where ambient temperatures remain high, rain is prevalent and high humidity is common, is that the glazing compound provides an ideal growth matrix for mildew spores. Mildew is a fungus which coats and discolors the surfaces where it is present, presenting an unsightly appearance. The mildew is difficult to completely eradicate once it has taken a foothold on a surface, and strong bleach solutions or the like must be used to remove the discoloration and kill the mildew. Applying bleach solutions to glazing compounds installed in a window is detrimental to the compound, since the bleach tends to cause hardening and cracking of the seal, resulting is a shortened useful life.

It is known to mix mildew inhibiting additives, known as mildicides, into paints, stains or coatings, since these compositions are liquid in nature and thus will readily accept the additive without any discernable change of consistency. In other words, the addition of the mildicide does not significantly alter the handling and application of the composition, nor does the addition significantly affect the final cured form of the composition. In contrast, glazing compound is relatively thick and non-liquid compound, which is not susceptible to easy mixing. More importantly, the addition of a mildicide, which is usually presented in a liquid or low viscous fluid form, dramatically alters the physical properties of the glazing compound with regard to handling, application and consistency, reducing the viscosity of compound such that it becomes too plastic. For this reason, there is currently no known glazing compound which incorporates a mildicide, and there is also no known method for adding a mildicide to prepared glazing compounds without ruining the consistency of the compound.

It is an object of this invention to provide a glazing compound which is resistant to mildew growth, where the physical properties of the compound are not significantly altered or degraded because of the addition of the mildicide. It is a further object to provide a method of manufacture for a glazing compound and mildicide mixture, where the mildicide can be added to the glazing compound after the compound has been packaged yet before application, where the physical properties of the compound are not significantly altered or degraded.

### SUMMARY OF THE INVENTION

The invention comprises in general a glazing compound or putty for use in sealing gaps between the glass panes of windows and the window frame, or an additive for a glazing compound, the glazing compound containing a mildicide, where the mildicide is added to the glazing compound after the compound has been manufactured and packaged, where the addition of the mildicide does not significantly alter or degrade the desired physical properties of the glazing compound. This is accomplished by adding an amount of calcium carbonate (CaCO₃), also known as calcite, to the glazing compound along with the mildicide, then mixing the composition using a paint shaker apparatus. The calcium carbonate and mildicide additive mixture ratio is approximately 8:3 by weight, with approximately 3 ounces of mildicide and 8 ounces of calcium carbonate added to a gallon of glazing compound, with the glazing compound preferably comprising a mixture of calcium carbonate, vegetable oil, marine oil and talc, the mildicide preferably comprising a mixture of chlorothalonil(2,4,5,6, -tetrachloroisophthalonitrile) and inert ingredients, and the calcium carbonate being finely ground.

### DETAILED DESCRIPTION OF THE INVENTION

Glazing compound or putty is a well known composition which is used to provide a flexible environmental seal between the glass panes of a window and the window frame structure itself. The glazing compound secures the pane within the frame, allows for expansion and contraction due to temperature changes, seals the gap between the pane and frame against the passage of air, water and particulates, and presents a pleasing visual presentation of a bright white color, or which can be painted if desired. Glazing compounds are now most commonly made without asbestos fibers, due to the hazardous nature of that material, and most commonly use varying amounts of calcium carbonate (CaCO₃) or calcite as the pigment, binder or filler material. The physical properties of the glazing compound will vary depending on the relative amount of calcium carbonate present, as well as its particulate size. A finely ground particle size promotes good length, stability and oil retention properties, but displays poor handling and knifing characteristics. A coarsely ground particle size, on the other hand, promotes oil separation, excessive bleeding and poor length properties, but does impart good handling and knifing characteristics. Thus a mixture of fine calcium carbonate particles with coarse calcium carbonate particles produces glazing compounds with a range of suitable physical properties depending on the application for the compound. The calcium carbonate is mixed with an oil, preferably a combination of vegetable oil, marine or fish oil, and/or mineral spirits, and also most preferably with an amount of talc, where the calcium carbonate is the major ingredient.

Representative mixtures for commercially available glazing compounds are shown in the following examples:

### EXAMPLE 1

For an elastic glazing compound, a mixture of approximately 7.5 wt. % marine oil, 4.0 wt. % vegetable oil, 42.5 wt. % fine calcium carbonate, 44.5 wt. % coarse calcium carbonate, and 1.5 wt. % talc.

### EXAMPLE 2

For a white linseed oil putty, a mixture of approximately 10.1 wt. % vegetable oil (linseed), 32.0 wt. % fine calcium carbonate, 56.9 wt. % coarse calcium carbonate, and 1.0 wt. % talc.

### EXAMPLE 3

For professional glazing compound,, a mixture of approximately 9.2 wt. % vegetable oil, 1.8 wt. % mineral oil, 32.0 wt. % fine calcium carbonate, 55.5 wt. % coarse calcium carbonate, and 1.5 wt. % talc.

### EXAMPLE 4

For premium grade glazing compound, a mixture of approximately 8.5 wt. % marine oil, 4.5 wt. % vegetable oil, 84.5 wt. % fine calcium carbonate, 1.1 wt. % clay, and 0.3 wt. % denatured alcohol.

To inhibit and prevent mildew growth in the glazing compound after it is installed on the window and exposed to the elements, a sufficient amount of mildicide is added to the packaged glazing compound prior to application, along with a sufficient amount of fine calcium carbonate, such that the desirable physical properties of the glazing compound are not significantly altered yet mildew growth is precluded. A suitable mildicide additive is produced by the Jomaps Company under the brand name M−1®, and consists of approximately 51.8% chlorothalonil(2,4,5,6,-tetrachloroisophthalonitrile) with the remainder being inert ingredients (mainly silica as a carrier). This additive has a relatively fluid composition and thus will significantly lower the viscosity of the glazing compound. To counter this negative effect, a suitable amount of fine calcium carbonate, often called whiting, is added to maintain the viscosity of the glazing compound. A suitable fine calcium carbonate is sold by the Synkoloid Company under the brand SYNKO®. The ratio of calcium carbonate to mildicide in the additive composition should be approximately 8:3 by weight. For a gallon of glazing compound, addition of approximately 3 ounces of mildicide and 8 ounces of calcium carbonate has proven suitable to provide a glazing compound which is highly resistant to mildew growth yet with the same physical properties as before the addition.

Contrary to intuition, it has been found that the mildicide and calcium carbonate mixture can be added to a pre-manufactured and packaged container of glazing compound in a relatively straightforward manner. The metal container for the glazing compound is opened by removing the lid, the mildicide and fine calcium carbonate is poured onto the top of the glazing compound and the container is resealed. The container is then placed into a standard paint shaking apparatus commonly used to mix paint and agitated for a few minutes. Even though the glazing compound is a relatively thick material, this method has proven fully suitable for thoroughly mixing the mildicide and calcium carbonate additives into the glazing compound. The resulting mildew-resistant glazing compound can be used and applied in the standard manner.

It is understood that substitutions for certain elements set forth above may be obvious to those skilled in the art, and the true scope and definition of the invention therefore is to be as set forth in the following claims.

I claim:

1. A glazing compound for use in sealing windows, said glazing compound comprising a mildicide present in sufficient amount to inhibit the growth of mildew in or on the glazing compound.

2. The compound of claim 1, further comprising fine calcium carbonate as an additive to said glazing compound and present in an amount such that the addition of said mildicide does not significantly alter the physical properties of said glazing compound.

3. The compound of claim 2, where the ratio by weight of said fine calcium carbonate to said mildicide is approximately 8:3.

4. The compound of claim 3, where said mildicide comprises chlorothalonil.

5. The compound of claim 4, where said mildicide comprises approximately 51.8% chlorothalonil.

6. The compound of claim 2, where said approximately 3 ounces of mildicide and approximately 8 ounces of fine calcium carbonate is present per gallon of glazing compound.

7. An additive composition for addition to a glazing compound used in sealing windows, the composition comprising a mildicide and fine calcium carbonate, whereby said glazing compound inhibits mildew growth when said composition is added, and whereby said fine calcium carbonate is present in amount such that the physical properties of said glazing compound are not significantly altered by the addition of the composition.

8. The composition of claim 7, where the ratio by weight of said fine calcium carbonate to said mildicide is approximately 8:3.

9. The composition of claim 8, where said mildicide comprises chlorothalonil.

10. The composition of claim 9, where said mildicide comprises approximately 51.8% chlorothalonil.

11. In a glazing compound containing calcium carbonate, the improvement comprising the addition of a composition comprising a mildicide and an additional amount of fine calcium carbonate, whereby said glazing compound inhibits mildew growth when said composition is added, and whereby said additional amount of fine calcium carbonate is present in amount such that the physical properties of said glazing compound are not significantly altered by the addition of the composition.

12. The composition of claim 11, where the ratio by weight of said fine calcium carbonate to said mildicide is approximately 8:3.

13. The composition of claim 12, where said mildicide comprises chlorothalonil.

14. The composition of claim 13, where said mildicide comprises approximately 51.8% chlorothalonil.
